(19) United States
(12) Patent Application Publication
(10) Pub. No.: US 2004/0225592 A1
(43) Pub. Date: Nov. 11, 2004

(54) Computer Implemented Method and System of Trading Indicators Based on Price and Volume

(76) Inventor: Eduardo Enrique Churquina, Dallas, TX (US)

Correspondence Address: EDUARDO ENRIQUE CHURQUINA, 8537 SOUTHWESTERN BLVD., APT. 2173, DALLAS, TX, 75206, US

(21) Appl. No.: 10/249,802

(22) Filed: May 8, 2003

(51) Int. Cl. G06F 17/60; G06F 15/00; G06F 17/18; G06F 101/14

(52) U.S. Cl. 705/37; 702/179

(57) ABSTRACT

A method and system for providing trading indicators for selected instruments traded in a market such as stocks, currency contracts, bonds, commodities contracts, options contracts, and futures contracts. The method and system create trading indicators using Time and Sales data as provide by exchanges or financial data providers. The method comprise parsing time, price and volume of individual transactions into a collection of volume per price bracket per time interval quantities, wherein each quantity is an aggregate volume of transactions executed during one of a set of sequential time intervals and executed at prices within one of a set of price brackets. The method generate trading indicators by using mathematical algorithms to score individual volume per price bracket per time interval quantities corresponding to an evaluation time interval against a population of individual volume per price bracket per time interval quantities corresponding to a set of previous time intervals. The system generates trading indicators in real time, without the time lag associated to traditional technical analysis indicators. The method and system can also generate trend indicators based on analysis of volume accumulation, and defines trading indicators based on maximum volume prices.

### BACKGROUND OF INVENTION

1. Field of Invention

This invention relates to market traded instruments such as stocks, currency contracts, bonds, commodities contracts, options contracts, and futures contracts. More particularly the invention relates to a method and system of trading indicators generated by applying mathematical algorithms to a set of aggregate volume of transactions occurred at narrow price brackets and at different time intervals.

2. Description of Prior Art

My invention defines a computer implemented method and system of trading indicators for market traded instruments such as stocks, currency contracts, bonds, commodities contracts, options contracts, and futures contracts.

My invention relates to a method and system of trading indicators created by applying mathematical algorithms to a collection of aggregate volume of transactions, each member of this collection being an aggregate volume of transactions occurred at narrow price brackets during each time interval of a set of sequential time intervals.

Furthermore, the essential feature of my invention is applying mathematical algorithms to such a collection spanning a plurality of time intervals. My invention also allows varying price brackets or time intervals according to instrument price, volume, or market indicators, as well as grouping together aggregate volumes corresponding to more than one time interval or more than one price bracket.

Following is a description of prior art related to collecting transaction information in narrow price brackets and methods using this information to generate trading indicators.

J. Peter Steidlmayer and The Chicago Board of Trade developed the Market ProfileÂ®system and Liquidity Data Bank Volume AnalysisÂ® for charting commodities prices (http://www.cbot.com/cbot/docs/handbook.pdf. The Liquidity Data Bank Volume AnalysisÂ®collects transaction information for each possible transaction price for a finite interval, usually a 24 hour day. It then identifies a “value area” as “the price range where 70 percent of the nonspread traded/cleared volume took place”. The method evolve a chart where annotated rectangles are drawn each time the value area overlaps the value area of a previous period. The method then draws conclusions comparing the total volume of each period, the location of the value area with respect of the price range of a single period, the trading activity of different types market participants (i.e. trades executed by local floor traders vs. trades executed by commercial clearing members trading for their house account.) Liquidity Data Bank Volume AnalysisÂ®falls short at not providing means for comparing cumulative volume of transactions at a singular prices and belonging to different time periods, a fundamental aspect of my invention. It also does not provide means for cumulating volume in a plurality of brackets bigger than the minimum price increment allowed in the exchange, neither methods to adjust those price brackets to the instrument price. It also lacks the capability of merging together volume for specific prices spanning more than one time period. All this features are covered in my invention presented here.

European Patent 1109122 A2, 20.06.2001 to Li and Chong: System For Charting Financial Market Activity. In FIG. 6 Li and Chong present a system for augmenting a conventional candlestick price-time chart for technical analysis of securities price movement. The system is characterized by means of analyzing trading activity data to determine for each discrete time interval a price bracket with substantially low trading activity or the highest trading activity. It also graphically identifies price brackets at the ends of the lower and upper shadow with minimal trading activity. The market activity compilation is done by time or volume means. Li and Chong proposed a very interesting system superimposing one element of volume data to traditional candlestick charting to identify the price bracket with highest activity or substantially lower activity. Being a display system Li and Chong system does not compare the actual volume of price brackets belonging to different time intervals, nor provide means for varying price brackets, or in essence, does not provide a method of deriving trading indicators from the system invented.

U.S. patent application Ser. No. 10/056,125 (not yet published) by Churquina, 01-24-2002: Integrated price and volume display of market traded instruments using price-volume bars. My invention Integrated price and volume display of market traded instruments using price-volume bars recognized the importance of aggregating volume occurred at narrow price brackets during each period of a set of discrete time intervals. That invention proposed a display showing a graphical representation of these cumulative volume totals for each time interval. Although a breakthrough in market instrument's activity display, it did not provided a method for generating trading indicators. My invention detailed here deals with a method for generating trading indicators that use the same basic data compilation techniques of my previous invention price-volume bars and can be used in conjunction with a price-volume bar chart.

### SUMMARY OF INVENTION

Accordingly, it is a primary object of my invention to provide traders with an analytical decision support tool for getting a better understanding of market forces at work on determined market instrument and let traders identify price trends at the earliest possible time. This tool should be repeatable, mathematical, user configurable, and able to run in real time. A secondary object of my invention is providing traders with a base price-series analysis tool that uses volume to recognize the most important price of each time interval. This tool can be used to build improved line and price-series based studies, much superior to studies built using closing prices for each interval.

My method lets traders have a unique insight into volume accumulation in narrow price brackets, and provide a novel methodology of analyzing that aggregate volume data.

All this processing can be done in real-time, so traders using the system of my invention in real time systems can have an edge on other traders, anticipate market movements and trade accordingly, ahead of traders using time-lagging tools commonly in use today.

My invention comprises steps of:

a) Time and Sales Data is obtained either in a storage media or by a suitable network link from financial data service providers or exchanges. This data comprise time, volume and price of transactions. If obtained online it can be real-time or delayed.

b) There is a set of sequential discrete time intervals and a set of discrete price brackets. The parameters to define time intervals span and price brackets amplitude are either user selected or predetermined. Smaller price and short intervals work best.

c) Compile a collection of volume per price bracket per time interval quantities, wherein each quantity is an aggregate volume of transactions executed during one time interval and executed at prices within one price bracket. For all subsequent description each volume per price bracket per time interval quantity will be referred to as “VPPB”, and the collection of VPPBs will be referred to as “VPPB set”.

d) Select a time interval for evaluation and apply filtering and preprocessing algorithms to select one or more subsets of the VPPB set. At least one subset must include VPPBs corresponding to a plurality of time intervals.

e) Select one or more VPPBs, at least one selected VPPB corresponding to evaluation time interval. Obtain one or more mathematical scores for each selected VPPB against one or more filtered and preprocessed subsets creating trading signals when such mathematical scores meet predetermined criteria.

In computer systems running the method of my invention in real time during market operation hours, these mathematical scores comprise, but are limited to, comparing VPPBs corresponding to current time interval to an average of VPPBs corresponding to immediately previous time intervals.

In this manner traders gain a comparative knowledge of current trading activity in a narrow price bracket versus trading activity in immediately previous time intervals. Personal experience with this method indicates this is a powerful and novel tool for traders using real time data feeds, as it is frequently possible to infer a turning point in a trend before the price trend actually changes direction.

Volume accumulation that leads changes in price trends can occur, depending in market conditions, during a period of time longer than the time interval in use at a particular moment. My invention include methods for varying time intervals according to volume or price variations, as well as merging together VPPBs corresponding to more than one time interval.

Additionally, since such volume accumulation can disperse over several price brackets, my invention includes previsions for varying price brackets as consequence of volatility parameters.

The maximum volume line is a special case of this indicator. It is a line created by joining prices within the price bracket with largest VPPB for each time interval.

The method of my invention can also indicate prices that will act as prices of support and resistance later on.

### BRIEF DESCRIPTION OF DRAWINGS

FIG. 1: Trading Indicator System Flowchart.

FIG. 2: Statistical Engine flowchart.

FIG. 3: Statistical Engine Flowchart.

FIG. 4: Trading Indicator System Flowchart.

FIG. 5: Trading Indicators Shown on Price-Volume Bar Chart.

FIG. 6: Trading Indicators with Merged VPPBs Shown on Price-Volume Bar Chart.

FIG. 7: Trading Indicators with Merged VPPBs Shown on Price-Volume Bar Chart.

FIG. 8: Trading Indicators with Merged VPPBs Shown on Price-Volume Bar Chart.

### DETAILED DESCRIPTION

Accordingly, it is a primary object of my invention to provide traders with a quantitative analytical decision support tool for getting a better understanding of market forces at work on determined market-traded financial instrument to let traders identify price trends at the earliest possible time.

For all subsequent description market instrument is used to refer to market-traded instruments such as stocks, currency contracts, bonds, commodities contracts, options contracts, and futures contracts traded in organized markets, exchanges, electronic markets, or ECNs.

It has been know for a time that volume affects, or drives, price trends. Traditionally, traders would observe Time and Sales scrolling information trying to identify and memorize key price levels where they observe an increase in trading activity, since that activity provides an insight of upcoming changes in the current price trend. Having this insight requires years of training trading on real time trading platforms, and is dependent entirely on the ability, concentration, and experience of a particular trader on a particular financial instrument.

There is a need for an efficient, easy to evaluate, and repeatable quantitative method and system that can analyze trading activity by parsing trading volume in user selectable narrow price brackets and user selectable time intervals.

The method of my invention provides a novel, surprisingly simple, yet powerful tool to apply mathematical algorithms to volume occurring at narrow price brackets, whereas traders can mathematically evaluate if current volume is likely to produce changes in the current price trend. Traders can evaluate in real time volume accumulation in narrow price brackets, having a reliable and repeatable method to uncover trading opportunities to take advantage of impending changes in the price trend.

The advantage of my invention is to provide traders with a method that let them identify price trend changes at the earliest possible time, even before the actual price trend change direction and much sooner than other time-lagging tool such as moving averages, etc.

Traders using the system of my invention in real time can have an edge on other traders, anticipate market movements and trade accordingly, ahead of traders using time-lagging tools commonly in use today.

Exchanges, financial data providers, or ECNs provide Time and Sales data comprising execution time, price, and volume of transactions. For all subsequent description the term “volume” refers to either number of shares traded, dollar amount of transactions, number of contracts traded, or open interest of futures and commodities, and the term “Time and Sales data” will refer to transaction information as provided by exchanges or data vendors, and comprising said execution time, price, and volume of executed transactions. Time and Sales Data can be received either in a data storage media or online through a suitable computer network connection from financial service providers or exchanges. Online data can be either “real time” data or “delayed” data, as commonly defined and provided by the exchanges and vendors.

Typically all data acquisition and computations will be done using a suitable computer systems connected to a suitable network connection to receive Time and Sales data, and to output the resulting trading indicators to other applications such as charting systems, automatic execution systems, remote users, etc. Furthermore, computer system architectures comprising several interconnected systems for data acquisition and processing operations can be used, as is typical for client-server, distributed computer architectures, fault tolerant systems, and web applications, and other networked systems.

The method of the present invention is now presented:

a) Establish a set of sequential time intervals compatible with available Time and Sales data. The user can select time intervals through a suitable user interface, preselected time intervals may be set, or parametric time intervals may be used. Time intervals can be of equal or different lengths. A minimum of 3 time intervals must be established.

b) Establish a set of price brackets compatible with available Time and Sales data: each price bracket being at least as broad as the minimum price increment allowed by the exchange where the market instrument is traded and being smaller than ⅕ of the difference between the high and the low expected transaction prices of said Time and Sales data. This expected high/low spread is estimated from historical data or as percentage of instrument price. A minimum of 5 price brackets must be established. Best performance results from using relatively small price brackets. Each market instrument will have a price bracket that produces the best results over a certain period. The user can set price brackets through a suitable user interface, they can be preselected, or parametric price brackets may be used. Price brackets need not be equal, unequal brackets can be used.

c) Compile a set of volume per price bracket per time interval quantities, wherein each volume per price bracket per time interval quantity is an aggregate volume of transactions executed during one time interval and executed at prices within one price bracket. For all subsequent description each volume per price bracket per time interval quantity will be referred to as “VPPB”, and the set of VPPBs as “VPPB set”. The VPPB set must include VPPBs corresponding to a least 3 different time intervals.

d) Select one time interval for evaluation. For all subsequent description this time interval will be referred to as “evaluation time interval.”

e) Selecting on or more subsets of the VPPB set using data filtering and preprocessing techniques. At least one subset must contain a plurality of time intervals preceding the evaluation time interval. Data filtering and preprocessing techniques are described below. For all subsequent description each one of these subsets will be referred as “population subset.”

f) Select one or more VPPBs for evaluation, at least one of those VPPBs must correspond to the evaluation time interval. For all subsequent description each one these VPPBs being evaluated will be referred as “evaluation VPPB.”

g) Apply mathematical algorithms to obtain one or more scores for each evaluation VPPB with respect to one or more population subset.

h) Compare scores with predetermined criteria and generate a trading indicator for each VPPB whose scores meet such criteria.

Typically, the evaluation criteria points to isolate price brackets with unusually high aggregate volume. In this manner trading indicators are created when volume accumulation occur at a particular price bracket, hinting of an impending change in the price trend, even before this change actually manifest itself.

Typically, the largest VPPB corresponding to a time interval is the evaluation VPPB and all VPPBs corresponding the preceding 20 time intervals as a population subset. A trading indicator is generated when the evaluation VPPB is larger than the population subset mean times a factor. This factor is empirical and different for each market instrument. The factor is user selectable through a suitable user interface between 2 and 10, and thus serves an indicator sensitivity selector.

In computer systems running the system of my invention in real time during market operation hours, the evaluation VPPB is a VPPB corresponding to the time interval including the current time, and population subset comprises VPPBs corresponding to an immediately preceding set of time intervals. In this manner real time trading indicators will be generated.

Traders now gain a comparative knowledge of current trading activity in a narrow price bracket versus trading activity in immediately previous time intervals. Personal experience with this method indicates this is a powerful and novel tool for traders using real time data feeds, as it is frequently possible to infer a turning point in a price trend before the price trend actually changes direction.

This is a tremendous advantage for short time traders as they can enter trades far ahead of traders using traditional time-lagging tools that will signal trades with several minutes of delay, giving traders using the method of my invention better execution prices and better liquidity since they can trade at moments of maximum activity at that particular price bracket.

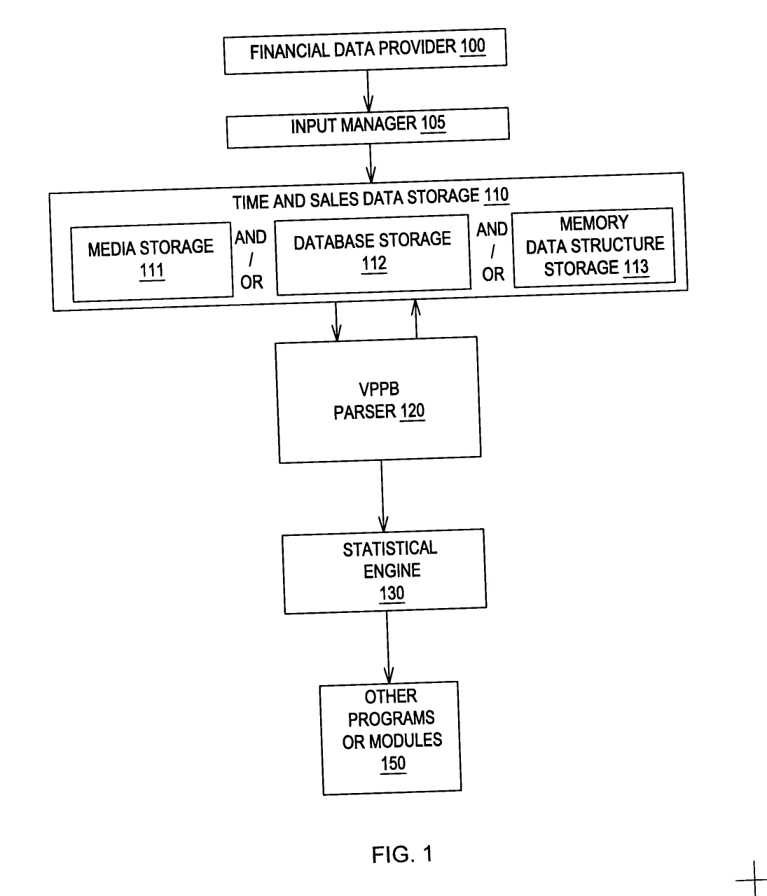

FIG. 1 shows a flowchart of my invention. Input Manager 105 receives Time and Sales data from Financial Data Provider 100 through a suitable network connection and protocol. Time and Sales Data Storage 110 stores such data in either Media Storage 111, and/or Database Storage 112, and/or in memory in Memory Data Structure Storage 113. VPPB Parser 120 compiles VPPB set. Statistical Engine 130 applies filtering and preprocessing to VPPB set to obtain population subsets, and applies preselected algorithms to obtain scores for each evaluation VPPB, comparing results to preselected criteria. A collection of trading indicators including VPPBs that met preselected criteria is output to Other Program or Module 150 that includes any program or module that will use the trading indicators. This uses comprises charting packages, automatic trading systems, remote users, storage in media or database, modules to calculate market wide or market sector indicators, or other uses for trading indicators.

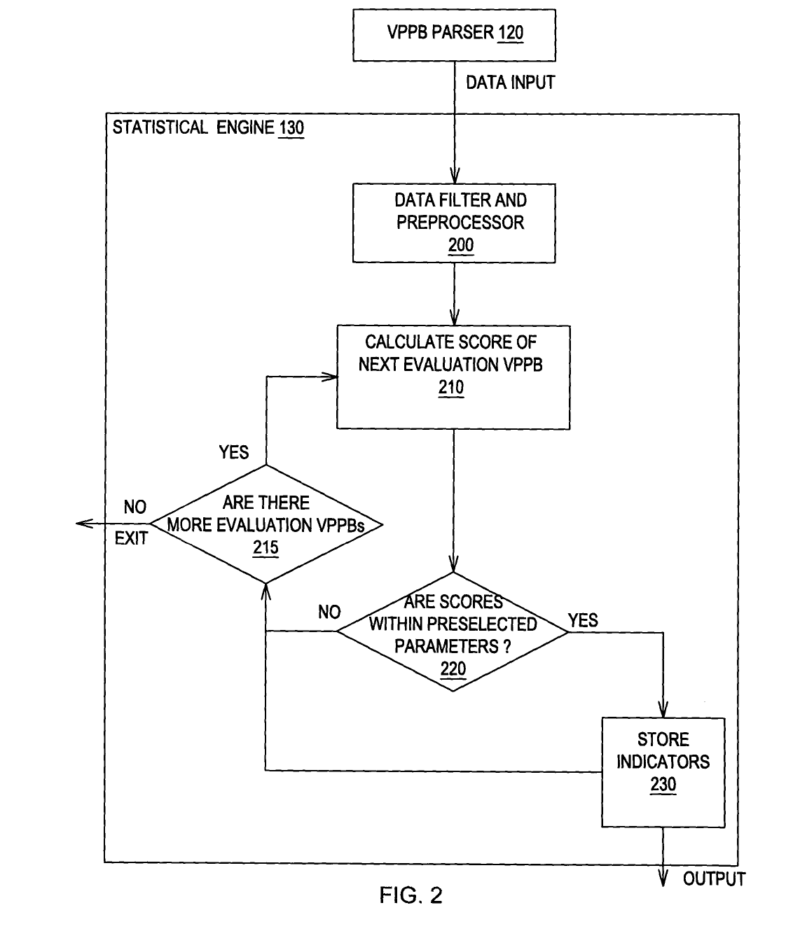

FIG. 2 shows a flowchart of Statistical Engine 130. Parsed VPPB data received from VPPB Parser 120 is fed to Data Filter and Preprocessor 200 where predetermined data filtering and preprocessing is applied to obtain population subsets. See VPPB Filtering and preprocessing below. Calculate Scores of Next Evaluation VPPB 210 obtains scores of evaluation VPPB against population subsets. Are Scores Within Preselected Parameters 220 compares scores of evaluation VPPB against predetermined criteria. If scores for an evaluation VPPB meet the criteria an indicator is created and stored by Store Indicators 230. Either after the indicator is stored, or if scores do not meet the predetermined criteria flow goes to Are There More Evaluation VPPBs 215. If there are more evaluation VPPBs to process flow pass to Calculate Scores Of Next Evaluation VPPB 210 to continue the process with such next evaluation VPPB. If there are not more evaluation VPPBs to process Statistical Engine 130 exits.

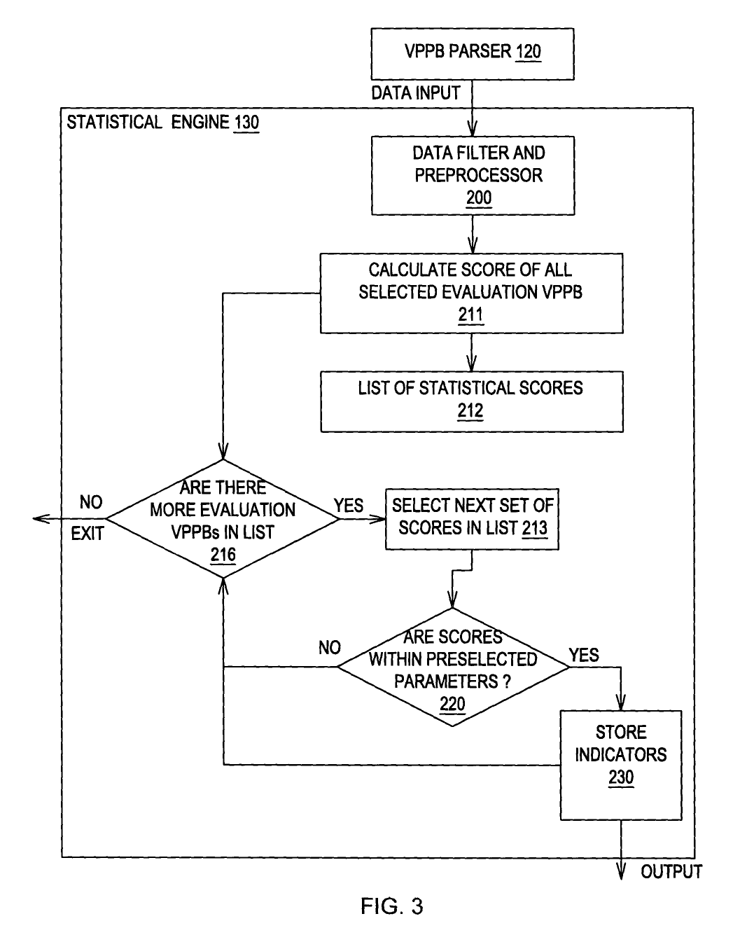

FIG. 3 shows an alternative flowchart of Statistical Engine 130. Parsed VPPB data received from VPPB Parser 120 is fed to Data Filter and Preprocessor 200 where predetermined data filtering and preprocessing is applied to obtain population subsets. See VPPB Filtering and preprocessing below. Calculate Scores Of All Selected Evaluation VPPBs 211 obtains scores of all evaluation VPPB against population subsets. These scores are stored in List Of Statistical Scores 212. Are There More Evaluation VPPBs In List 216 checks if there are remaining evaluation VPPBs to process. If Yes, Select Next Set Of Scores In List 213 fetches from List of Statistical Scores 212 the set of scores corresponding to next evaluation VPPB and passes them to Are Scores Within Preselected Parameters 220, that compares scores against preselected criteria. If the score meets the criteria Store Indicators 230 stores it. Either after the indicator is stored, or if scores do not meet the criteria, flow goes to Are There More Evaluation VPPBs In List 216. If Yes, Select Next Set Of Scores In List 213 fetches next set of scores in List Of Statistical Scores 212 and continues the loop as before; if No, Statistical Engine 130 exits.

### DETAILED DESCRIPTION OF PREFERRED EMBODIMENT

In a preferred embodiment the method of my invention runs in a computer system receiving market data in real time, and where:

a) The financial instrument is a stock in a public traded company.

b) Time intervals are user-selectable through an appropriate user interface, comprising 1, 2, 3, and 5-minute intervals choices.

c) Price brackets are user-selectable through an appropriate user interface comprising $0.01, $0.02, $0.03, $0.04, and $0.05 brackets choices.

d) VPPBs are the aggregate volume of all transactions executed during one time interval and executed at prices within one price bracket.

e) The evaluation time interval is the time interval containing the current time.

f) The population subset is the subset of the VPPB set filtered to contain only all VPPBs corresponding to the 10 immediately previous time intervals.

g) The evaluation VPPB is the largest VPPB corresponding to the evaluation time interval.

h) The score is the statistical z-Score of the evaluation VPPB with respect to the population subset.

i) The trading indicator criteria is the comparison of z-Score with a user-selectable factor. The user selects the factor through a suitable user interface and so actually sets the system sensitivity.

Trading indicators are fed to a Price-Volume Bar chart display system that overlay trading indicators on top of the chart to let traders evaluate impending price trends and enter transactions accordingly ahead of other traders.

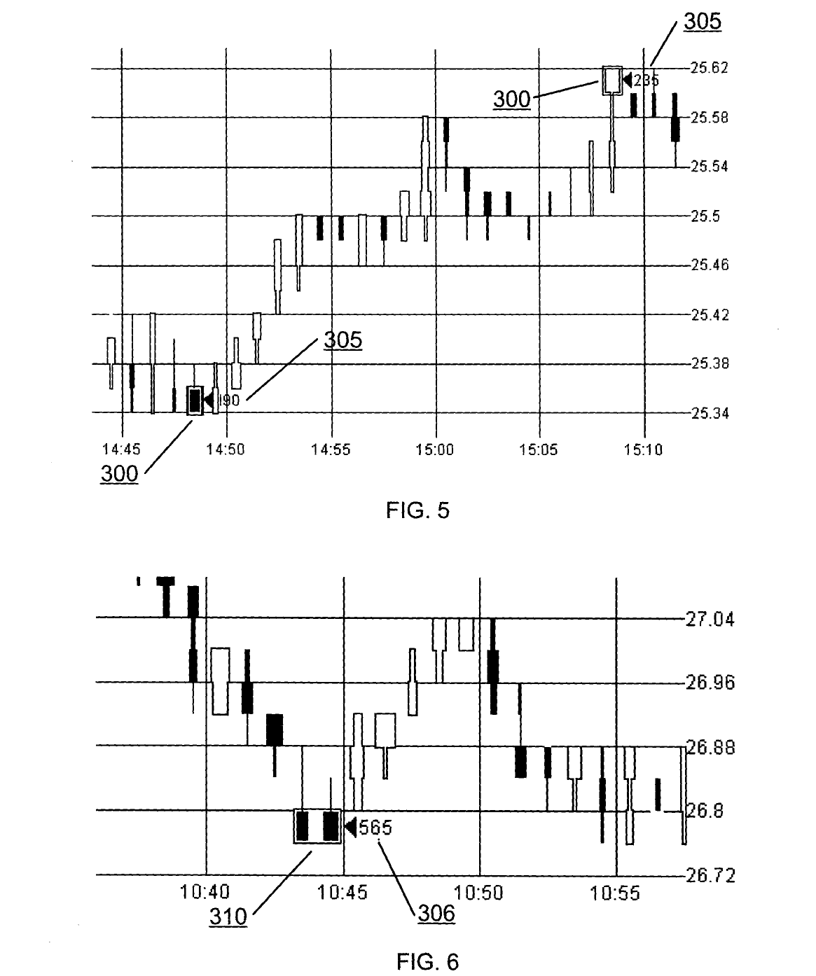

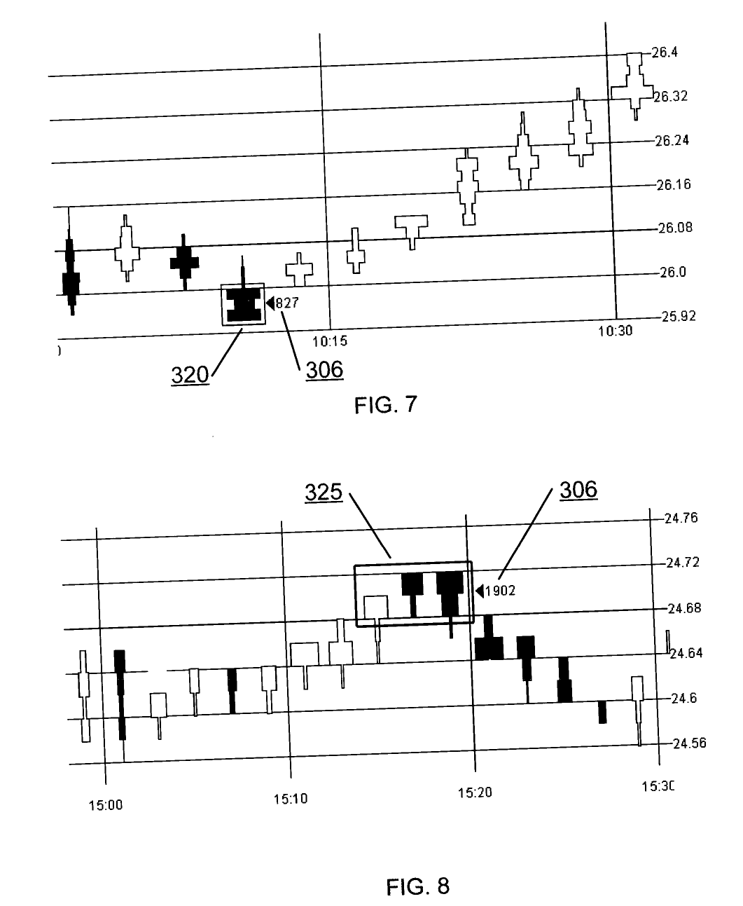

FIG. 5, FIG. 6, FIG. 7, and FIG. 8 show indicators of the present invention plotted on top of a stock chart. Chart shown is my invention Price-Volume Bar chart covered under separate Patent Application; reference Bibliography.

FIG. 5 shows single VPPBs highlighted indicating trading opportunities. Highlighted VPPB 300 is the VPPB that met predetermined indicator criteria, while quantity 305 is the aggregate volume of highlighted VPPB expressed in lots of 100.

### DETAILED DESCRIPTION OF OTHER EMBODIMENTS

Several refinements and modifications can be applied to the preferred embodiment of my invention to adapt it to different financial instruments, different time spans, varying market conditions and trading styles These refinements and modifications can be applied individually or combined together in any quantity necessary.

Refinements or modifications such as:

Parametric Time Intervals

Parametric Time Intervals refers to algorithmically set the length of time intervals at run time based on analysis of volume, price, or both. This process may result on time intervals of equal or different length.

f) Time intervals can vary according to trading volume. For example, time intervals end only when the total volume for the interval exceeds a predetermined minimum.

g) Time intervals can vary according to price action. For example, time intervals end when the difference between time interval's high and low exceeds a predetermined maximum.

Parametric Price Brackets

Parametric Price Brackets refers to algorithmically set the amplitude of price brackets at run time based on analysis of volume, price, or both. This process might result on price brackets of equal or different amplitude.

Price brackets can vary according to the price of the market instrument being considered. For example, it can be predetermined that price bracket will be 0.1% of open price.

d) Price brackets can vary according with market volatility. For example: i) price brackets can be predetermined to be 1/20^{th of the difference of the high and low of the VPPB set; ii) they can be calculated as} 1/10^{th of the difference between the high and low of the last hour, etc.}

Price brackets can vary and be different for each time interval. For example, price brackets defined as the larger of a predetermined fraction of the difference between the corresponding time interval high and low or the minimum price increment allowed for the market instrument in the exchange being monitored. In this manner time intervals with more internal volatility will have broader price brackets.

Data Filtering and Preprocessing

Data Filtering and Preprocessing refers to algorithms used to select and change data from the VPPB set to obtain population subsets. Filtering involves selecting certain VPPBs and excluding others from population subsets, while preprocessing refers to algorithmically altering VPPB data before building population subsets. Depending on the market instrument being analyzed any combination of filters and preprocessors may be used.

Filtering

Obtain multiple population subsets by time. For example: i) Obtain two population subsets, one including all VPPBs corresponding to the last 10 time intervals, and a second one including all VPPBs corresponding to the last 20 time intervals; ii) Obtain two population subsets, one including all VPPBs corresponding to the last 10 time intervals and a second containing only the largest VPPB of each last 10 intervals; iii) Obtain two population subsets, one including all VPPBs corresponding to the last 10 time intervals, and a second including all VPPBs corresponding to the 10 time intervals preceding the first subset.

a) Limiting population subsets by price-volume action. The time limits of VPPB subsets can be dynamically determined to restrict the set time span by using either: i) Price action algorithms, such as restricting the time span of VPPB subsets between evaluation time interval and time of last price trend change, either low or high. ii) Volume action algorithms such as restricting the time span of VPPB subsets between evaluation time interval and time of last significant VPPB, a significant VPPB being a VPPB with value larger than a predetermined value or VPPB that generated an indicator. iii) Algorithms involving price and volume parameters such as restricting the time span of VPPB subsets between evaluation time interval and time of last significant VPPB with corresponding price bracket that is a predetermined percentage higher or lower than last received transaction.

b) High/low filters to filter out non-significant VPPBs out of population subsets. For example: i) not including in population subsets VPPBs with value higher than a preselected value; ii) not including in population subsets VPPBs with values lower than a preselected value; iii) not including in population subsets VPPBs with values higher than a preselected value and those with lower value than a preselected value; iv) including in population subsets only VPPBs with largest value for each interval; v) clipping population subsets of a number or percentage of the largest VPPBs, smallest VPPBS, or both; vi) including in population subsets only VPPBs with values above a certain percentage of last VPPB that generated an indicator; vii) including in population subsets only VPPBs with values above a certain percentage of the average of today's VPPBs that generated indicators; etc.

Preprocessing

a) Merging VPPBs of similar price brackets but corresponding to adjacent or near adjacent different time intervals. Two or more VPPBs of different time intervals can be merged into one VPPB and treated as a single VPPB for score calculation. This feature of my invention address situations where volume accumulation at single price brackets span more than one time interval. Merged VPPBs need not correspond to adjacent time intervals. Typically, the largest VPPBs corresponding to adjacent or near adjacent time intervals will merge if those VPPBs have the same price bracket. FIG. 6 shows merging VPPBs of similar price brackets but different time intervals. Highlighted Merged VPPBs 310 is the merged VPPB that met predetermined indicator criteria, while quantity 306 is the aggregate volume of Merged VPPBs 310 expressed in lots of 100.

b) Merging VPPBs of similar time interval but different adjacent or near adjacent price brackets. Two or more VPPBs of different price brackets but corresponding to one time interval can be merged into one VPPB and treated a single VPPB for quantitative analysis. This feature of my invention address situations where volume accumulation at single time intervals span more than one price bracket. Merged VPPBs need not correspond to adjacent price brackets. Typically, the largest VPPB will merge with adjacent or near adjacent VPPBs with volumes that exceed a predetermined percentage of the largest VPPB, i.e. where adjacent or near adjacent VPPBs are bigger than 50% the largest VPPB. This technique is equivalent to varying price brackets based on volume analysis. FIG. 7 shows merging VPPBs of similar time interval but different price brackets. Highlighted Merged VPPBs 320 is the merged VPPB that met predetermined indicator criteria, while quantity 306 is the aggregate volume of Merged VPPBs 320 expressed in lots of 100.

c) Merging VPPBs of different but adjacent or near adjacent time interval, and different but adjacent or near adjacent price brackets. Two or more VPPBs of different price brackets and different corresponding time interval can be merged into one VPPB and treated as a single VPPB for performing mathematical algorithms if their price brackets and time intervals are closer than predetermined amounts. This feature of my invention address situations where volume accumulation span more than one time interval and span more than one price bracket. Typically, merging joins together relatively large VPPBs, i.e. 50%+of largest VPPB of a time interval, with other relatively large VPPBs that appear in the range +/−two price brackets and +/−two intervals. Merging VPPBs is a powerful feature of my invention, as it relax strict limitations of time intervals and price brackets to adapt analysis of volume accumulation to particular characteristics of the market instrument being analyzed, such as volatility, day volume, time of the day, etc. FIG. 8 shows merging VPPBs of different time interval and different price brackets. Highlighted Merged VPPBs 325 is the merged VPPB that met predetermined indicator criteria, while quantity 306 is the aggregate volume of Merged VPPBs 325 expressed in lots of 100.

Scoring

Refinements to scoring procedure are now presented:

a) Scoring an evaluation VPPB against a population subset comprises: i) compare an evaluation VPPB to a measure of central tendency of a population subset, such as the mean, median, or mode.

b) Score an evaluation VPPB against a weighted average VPPBs in population subsets, where each VPPB is multiplied by a factor inversely proportional to the time difference between its corresponding time interval and evaluation time interval.

c) Calculate the variability of population subsets distribution and calculate the location of evaluation VPPBs in that distribution, such as: i) obtain the statistical z Score that separate the sample in a predetermined proportion, i.e. the lower ⅞ and the higher ⅛, and generate trading indicators when an evaluation VPPB z-Score falls within the high ⅛ ii) applying other statistical analysis to compare evaluation VPPBs to a measure of variability of the distribution of population subsets.

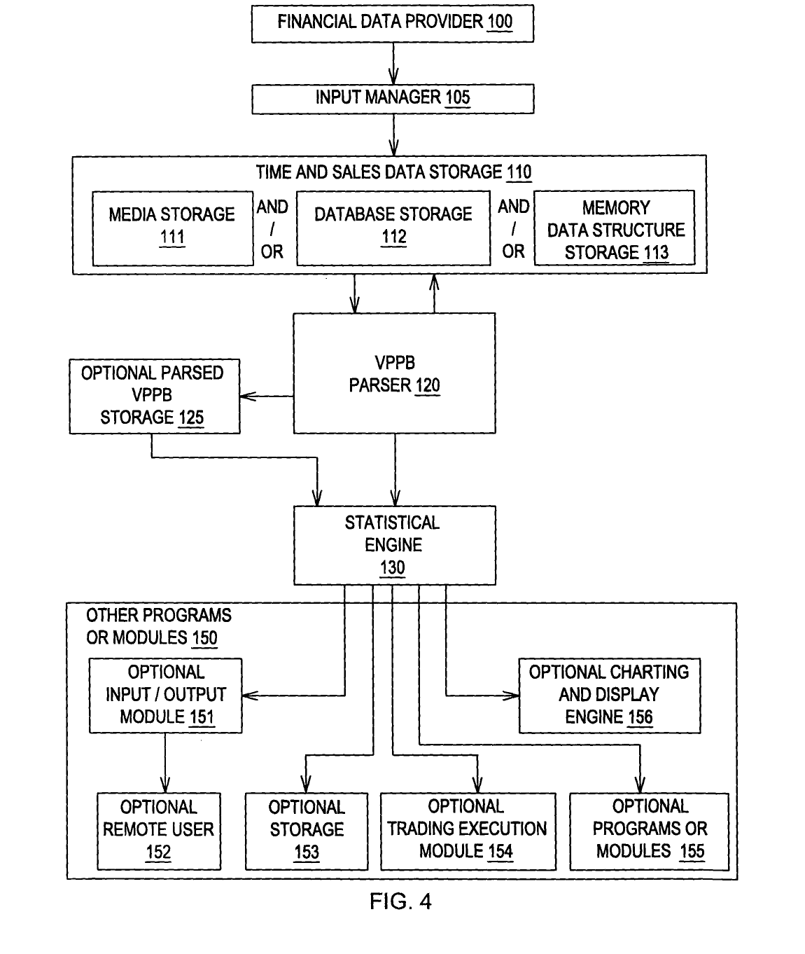

FIG. 4 shows a flowchart of my invention with optional modules. Input Manager 105 receives Time and Sales data from Financial Data Provider 100 through a suitable network connection and protocol. Time and Sales Data Storage 110 stores such data in either Media Storage 111, and/or Database Storage 112, and/or in memory in Memory Data Structure Storage 113. VPPB Parser 120 parses Time and Sales data to obtain the VPPB set. VPPB-parsed data can optionally be stored in Optional Parsed VPPB Storage 125 for later use. Statistical Engine 130 creates population subsets and computes scores of evaluation VPPBs, generating a collection of trading indicators from those scores that meet preselected criteria. This collection of trading indicators output from Statistical Engine 130 is the input to Other Programs or Modules 150. One or more of this applications/modules are present at any time. Shown as sample of other applications or modules are: Optional Input/Output Module 151 that receives indicator data and forwards it to Optional Remote User 152 through a suitable network connection and protocol; Optional Storage 153 to store indicator data; Optional trading Execution System 154 that executes transactions based on trading indicators data; Optional Charting and Display Engine 156 displays trading indicators over a chart; furthermore Optional Programs or Modules 155 represents yet any other possible application for trading indicators.

Maximum Volume Prices and Maximum Volume Line

A maximum volume price is the center price of the price bracket with largest VPPB of a particular time interval. Joining with a line the maximum volume prices of each time interval give us the Maximum Volume Line. Using maximum volume prices is a powerful concept, since the Maximum Volume Line passes through the most important price for each time interval: the price with highest market participation. Maximum volume prices can be used in lieu of the traditional closing prices to build much more significant price studies for understanding market behavior and indicating trading opportunities. Such studies comprise moving averages, Bollinger bands, MACD, price oscillators, etc.

Support and Resistance

Technical analysis call support and resistance levels those prices that seem to hold prices from breaking through either downward, support, or upwards, resistance. I had verified that volume accumulation at narrow price brackets leads to the establishment of levels of support and resistance. A supplemental support and resistance trading indicator is generated when anomaly high volume accumulation is detected in a narrow price bracket, thus signaling traders that a significant price level has been established. This is usually marked with a horizontal line of limited time span to warn traders about these specific levels later if the market instrument is trading close to those levels.

Trend Evaluation Models

Price brackets with strong volume accumulation, significant VPPBs, signal a potential trend modification. It is possible to predict, with a certain percentage of certainty, the direction the market will take by mathematically analyzing volume and price patterns of earlier time intervals.

Technical analysts assume that, in essence, the market has a state, and that state can only be either trending or sideways. Trending markets are when prices have a clear tendency to go up or down, and sideways market are when prices tend to stay within a relatively narrow horizontal range over a period of time. Trending markets may be downtrending or uptrending. The definition of uptrending, downtrending, and sideways markets is highly subjective, and dependent on the time frame being considered: a market may appear as sideways when a seen on a daily chart, while appearing trending in a 30 minutes interval.

Trend change is a transition between any of those states:

downtrending, uptrending, and sideways.

To predict a future trend direction we will add an additional step to my invention: applying a trend evaluation model to particular VPPB identified as trading indicator.

The trend evaluation model of my invention comprises one or more of the following steps:

a) Select one or more trend population subsets of VPPB set using a combination one or more of the filtering and preprocessing techniques discussed above. These trend population subsets may or may not be the same, and may or may not be similar to those population subsets used in previous steps.

b) Depending on market conditions apply any of the following methods to one or more trend population subsets to generate indicators of future trends:

On trending markets:

i) Calculate an above total aggregating the volume of VPPBs with corresponding price brackets above the price bracket of evaluation VPPB, and a below total aggregating the volume of VPPBs with corresponding price brackets below the price bracket of evaluation VPPB; volume of price brackets similar to price bracket of evaluation VPPB can be either ignored, added to above total, or added to below total.

ii) Compare above total to below total and a trend change indicator if: the selected market instrument price is uptrending and below total is larger than above, or market instrument is downtrending and above total is larger than below total.

Optionally, above total or below total may be multiplied by a factor, for example trend indication will be generated only if one total is more than two times the other total.

On sideways markets:

i) Create an above subset by selecting VPPBs members of the trend population subset whose corresponding price bracket is above the evaluation price bracket, and a below subset by selecting VPPBs members of the trend population subset whose corresponding price bracket is below the evaluation price bracket.

ii) Calculate the statistical regression line of each above subset and below subset using the data pair price/time of each VPPB, where price is the center price of the corresponding price bracket, and time is the time between the corresponding time interval and evaluation time interval, expressed units of time or number of time intervals.

iii) Interpolate the slopes of the two regression lines. The resulting slope indicates the predicted direction of the market for this particular instrument, and thus we can create a directional indicator of future price trend if this slope is steeper than a predetermined minimum.

1. A computer implemented method for creating trading indicators for a financial instrument traded in a market comprising:
a) having a set of sequential time intervals, and
b) having a set of price brackets, wherein each price bracket is narrower than ⅕ of the estimated difference between highest and lowest transaction prices of the total time span of said set of sequential time intervals, and
c) computing a set of VPPB quantities, wherein each VPPB quantity is an aggregate of said financial instrument volume of transactions executed during one time interval of said set of sequential time intervals and executed at prices within one price bracket of said set of price brackets, and
d) selecting an evaluation time interval from said set of sequential time intervals, and
e) selecting one or more population subsets of said set of VPPB quantities by applying predetermined data filtering and preprocessing means, and at least one of said population subsets comprising VPPB quantities corresponding to a plurality of time intervals preceding said evaluation time interval, and
f) selecting one or more evaluation VPPB quantities, at least one evaluation VPPB quantity corresponding to said evaluation time interval, and
g) applying mathematical algorithms to obtain one or more scores for each said evaluation VPPB quantity with respect to one or more of said population subsets, and
h) creating a trading indicator when said scores meet predetermined criteria.

2. The method of claim 1 wherein said data filtering and preprocessing means restrict one or more of said population subsets using mathematical algorithms comprising said transaction time of said financial instrument.

3. The method of claim 1 wherein said data filtering and preprocessing means restrict one or more of said population subsets using mathematical algorithms comprising said transaction volume of said financial instrument.

4. The method of claim 1 wherein said data filtering and preprocessing means restrict one or more of said population subsets using mathematical algorithms comprising said transaction price of said financial instrument.

5. The method of claim 1 wherein said data filtering and preprocessing means restrict one or more of said population subsets using mathematical algorithms comprising a market index.

6. The method of claim 1 wherein said data filtering and preprocessing means merge said VPPB quantities corresponding to a single said time interval and corresponding to adjacent or near adjacent price brackets.

7. The method of claim 1 wherein said data filtering and preprocessing means merge said VPPB quantities corresponding to adjacent or near adjacent time intervals and corresponding to adjacent or near adjacent price brackets.

8. The method of claim 1 wherein said time intervals span is determined by mathematical algorithms comprising transaction volume of said financial instrument.

9. The method of claim 1 wherein said time intervals span is determined by mathematical algorithms comprising transaction prices of said financial instrument.

10. The method of claim 1 wherein said price brackets amplitude is determined by mathematical algorithms comprising transaction volume of said financial instrument.

11. The method of claim 1 wherein said price brackets amplitude is determined by mathematical algorithms comprising transaction prices of said financial instrument.

12. The method of claim 1 wherein said scores are statistical deviation scores between said evaluation VPPB quantity and a measure of central tendency of said subset.

13. The method of claim 1 wherein said scores are statistical z-Scores of said evaluation VPPB quantity with respect to one or more said population subsets.

14. The method of claim 1 further including the steps of:
a) Obtaining a trend indicator by applying a trend evaluation model to one or more evaluation VPPB.

15. A computer implemented method for creating trading indicators for a financial instrument traded in a market using a computer system receiving data for said financial instrument in real time comprising:
a) having a set of sequential time intervals, wherein said set of sequential time intervals comprises a time interval including the current time and a plurality of prior time intervals, and
b) having a set of price brackets, wherein each price bracket is narrower than ⅕ of the expected difference between highest and lowest transaction prices of said financial instrument for the total time span of said set of sequential time intervals, and
c) computing a set of VPPB quantities, wherein each VPPB quantity is an aggregate of said financial instrument volume of transactions executed during one time interval of said set of sequential time intervals and executed at prices within one price bracket of said set of price brackets, and
d) selecting as evaluation time interval the time interval including current time, and
e) selecting one or more population subsets of said set of VPPB quantities by applying predetermined data filtering and preprocessing means, and one or more said population subsets comprising VPPB quantities corresponding to a plurality of said prior time intervals, and
t) selecting one or more evaluation VPPB quantities, at least one evaluation VPPB quantity corresponding to said evaluation time interval, and
g) applying mathematical algorithms to obtain one or more scores for each said evaluation VPPB quantity with respect to one or more of said population subsets, and
h) creating a trading indicator when said scores meet predetermined criteria.

16. A computer implemented method for creating trading indicators based on a set of maximum volume prices of a financial instrument traded in a market comprising:
a) having a set of sequential time intervals, and
b) having a set of price brackets, wherein each price bracket is narrower than ⅕ of the estimated difference between highest and lowest transaction prices of the total time span of said set of sequential time intervals, and
c) computing a set of VPPB quantities, wherein each VPPB quantity is an aggregate of said financial instrument volume of transactions executed during one time interval of said set of sequential time intervals and executed at prices within one price bracket of said set of price brackets, and
d) compiling a set of maximum volume prices wherein each maximum volume price is a price within the price bracket with largest VPPB of all price brackets corresponding to a single time interval, and said set of maximum volume prices includes VPPB quantities corresponding to a plurality of time intervals, and
e) applying mathematical algorithms to said set of maximum volume prices.
